(19) United States
(12) Patent Application Publication
(10) Pub. No.: US 2016/0186925 A1
(43) Pub. Date: Jun. 30, 2016

(54) CLIP AND RAIL ATTACHMENT SYSTEM

(71) Applicant: FITNEFF INC., Calgary (CA)

(72) Inventor: Ron Bettin, Calgary (CA)

(21) Appl. No.: 14/985,215

(22) Filed: Dec. 30, 2015

(30) Foreign Application Priority Data
Dec. 31, 2014 (CA) 2876325

(51) Int. Cl. F16M 13/02

(52) U.S. Cl. CPC F16M 13/022; F16M 2200/025

(57) ABSTRACT

A clip and rail attachment system, for mounting an accessory. comprises at least one rail member having a longitudinal axis, a first end, a second end, a channel that extends substantially along the longitudinal axis, at least one end opening, and a longitudinal opening. The system also comprises at least one rail clip, having a channel engagement member and a mounting member. The rail clip is suitable for slidable movement along the rail member and for supporting the accessory on the mounting member. The channel communicates with the at least one opening and the longitudinal opening allows for the mounting member to extend out from the channel while clip is supported by the rail. The channel and the at least one opening are each of suitable size and dimension to receive the channel engagement member, so as to allow rail clip to be captured by the rail member and to slide therealong in a direction that is substantially parallel to the longitudinal axis.

### FIELD OF THE INVENTION

This invention relates generally to attachment devices used to secure accessories onto a piece of equipment or other member. More particularly, the invention relates to slidably adjusting and securing accessories onto an elongate rail or groove in a piece of fitness, office or other equipment.

### BACKGROUND OF THE INVENTION

The background information discussed below is presented to better illustrate the novelty and usefulness of the present invention. This background information is not admitted prior art.

Existing clip and rail attachment systems typically feature an elongate rail member attached to, or embedded within, a piece of equipment or surface and a plurality of sliding clip or clamping members that are slidably adjustable along, and securable to, the rail member. Usually, such attachment systems feature one or more grooves, slots or channels within the rail to accept a portion of the clip or clamping member and a thumbscrew, knob or bolt on the clip to apply tension from the clip or clamping member to then securely mount same to the rail. One example of such a rail and clamp mounting system is described in U.S. Pat. No. 8,132,701.

However, such thumbscrew, knob and bolt tensioned systems requires a user to exercise judgment as to how much torque to apply to the thumbscrew, knob or bolt, to ensure proper fastening of the clip or clamping member to the rail. If insufficient torque is applied, then there is a risk of the clip or clamping member disengaging from the rail or sliding to an undesirable position therealong. If too much torque is applied, there is a risk of stripping or breaking the thumbscrew, knob or bolt mechanism. Furthermore, a thumbscrew or bolt may not allow for easy fastening and unfastening operation when used in tight spaces or when the equipment is positioned adjacent walls. Such screw, knob or bolt may also require the use of additional tools to properly fasten and unfasten the clip member to and from the rail.

Therefore, what is needed is a clip and rail attachment system that does not suffer from these disadvantages.

### BRIEF DESCRIPTION OF THE DRAWINGS

Referring to the drawings, several aspects of the present invention are illustrated by way of example, and not by way of limitation, in detail in the figures, wherein:

FIGS. 1a-1d are front perspective views of a preferred embodiment of the clip and rail attachment system, showing a preferred sequence of installation of the clip members into the rail;

FIGS. 2a and 2b are side perspective views of the clip and rail attachment system of the embodiment of FIG. 1a, with the clips in the unlocked and sliding position and with an accessory mounted to the clips;

FIGS. 2c and 2d are side perspective views of the clip and rail attachment system of the embodiment of FIG. 1a, with the clips in the locked position and with an accessory mounted to the clips;

FIGS. 2e and 2f are side perspective views of the clip and rail attachment system of the embodiment of FIG. 1a, with the clips in the locked position, with the secondary lock engaged and with an accessory mounted to the clips;

FIGS. 3a-3d are perspective and end views of the attachment rail portion of the system of the embodiment of FIG. 1a;

FIGS. 4a-4d are perspective and end views of another embodiment of an attachment rail portion for a clip and rail attachment system;

FIGS. 5a-5c are perspective, end and sectioned-end views of the clip and rail attachment system of the embodiment of FIG. 1a, with the clips in the unlocked and sliding position;

FIGS. 6a-6c are perspective, end and sectioned-end views of the clip and rail attachment system of the embodiment of FIG. 1a, with the clips in the locked position;

FIGS. 7a-7c are perspective, end and sectioned-end views of the clip and rail attachment system of the embodiment of FIG. 1a, with the clips in the locked position and with the secondary lock engaged;

FIGS. 8a-8c are perspective and end views of the clip and secondary lock portions of the system of the embodiment of FIG. 1a, with the secondary lock in the unlocked or disengaged position;

FIGS. 8d-8f are perspective and end views of the clip and secondary lock portions of the system of the embodiment of FIG. 1a, with the secondary lock in the locked or engaged position;

FIGS. 9a-9c are exploded perspective and exploded sectioned-perspective views of the clip and secondary lock portions of the system of the embodiment of FIG. 1a; and

FIGS. 10a-10b are perspective views of the accessory clip portion of the system of the embodiment of FIG. 1a.

### DEFINITION SECTION

Horizontal plane, as used herein, refers to a plane that is horizontal at a given point if it is perpendicular to the gradient of the gravity field at that point, in other words, apparent gravity is what makes a plumb bob hang perpendicular to the plane at that point. In other words a horizontal plane in the plane that is perpendicular to the line that passes through the center of the Earth.

Vertical plane, as used herein, refers in astronomy, geography, geometry, and related sciences and contexts, to a direction passing by a given point if it is locally aligned with the gradient of the Earth's gravity field, i.e., with the direction of the gravitational force (per unit mass, i.e. gravitational acceleration vector) at that point.

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

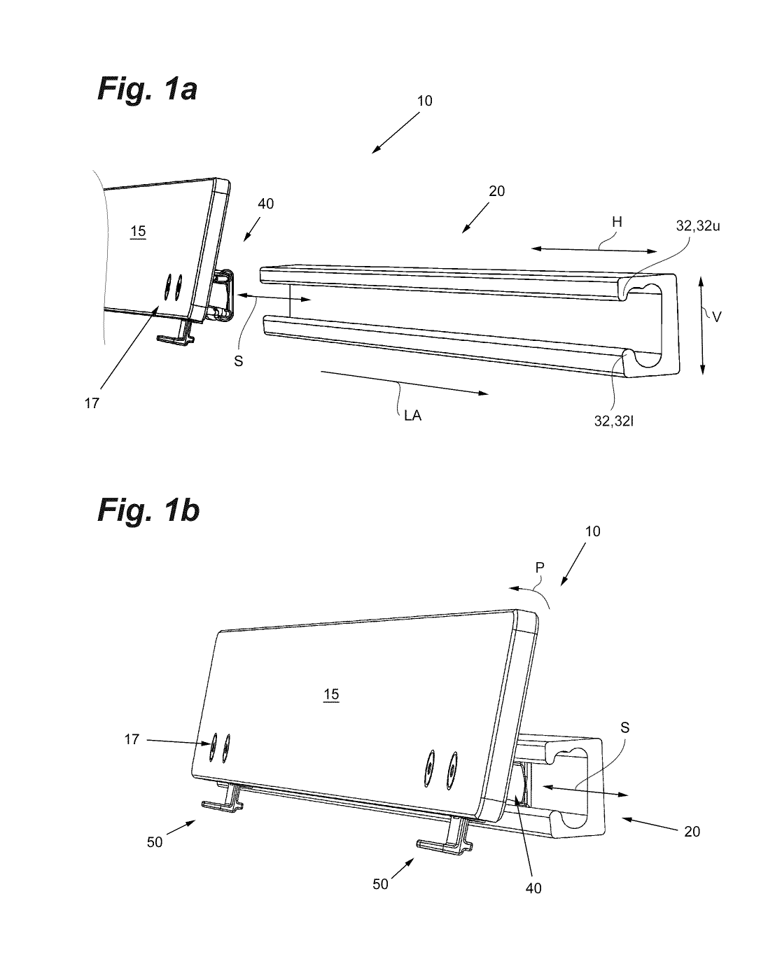

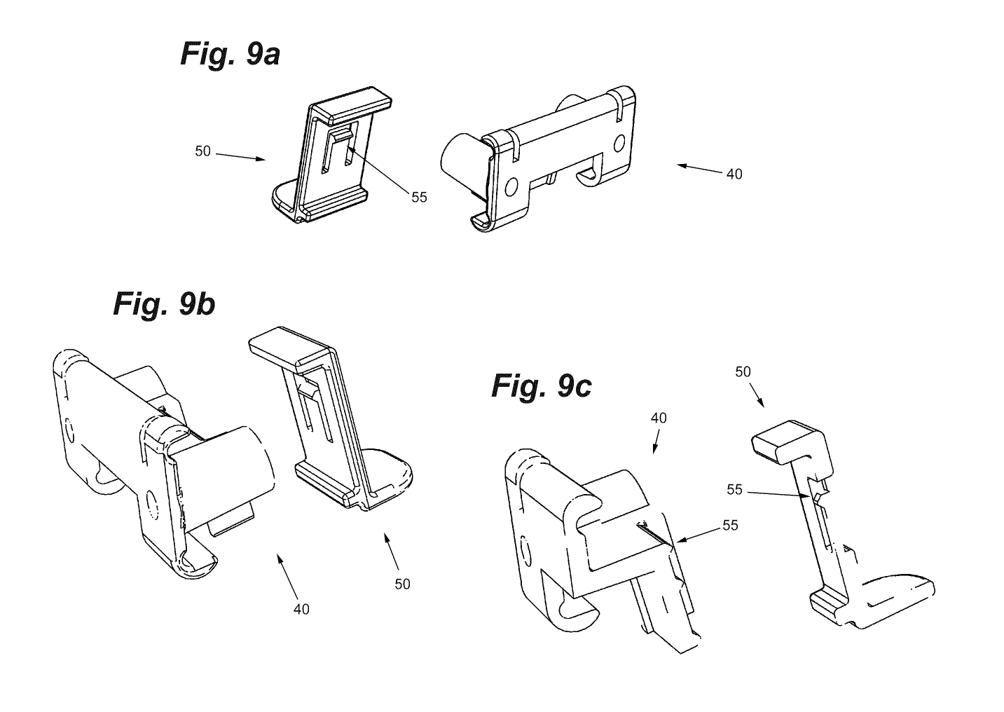

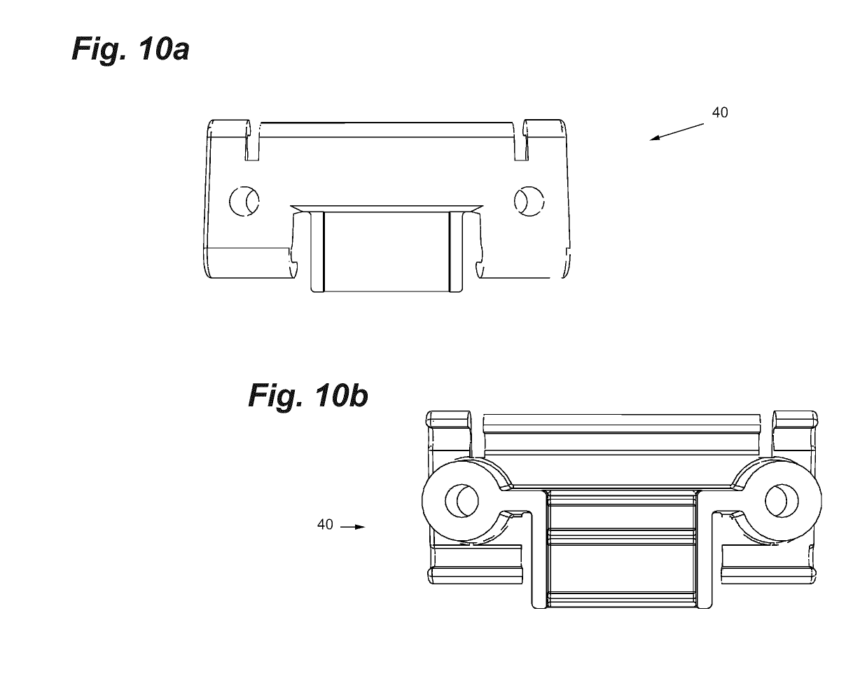

A first preferred embodiment of the clip and rail attachment system 10 of the present invention is shown in FIGS. 1a-3d and 5a-10b and is designed to be attached in a conventional manner to a piece of equipment or to a surface such as a wall or panel (not shown). The system comprises at least one rail member 20 and at least one rail clip 40 suitable for slidable movement S along the rail member 20 and suitable for supporting and mounting an accessory 15 and supporting same from the rail 20.

Rail member 20 is preferably an elongate member having a longitudinal axis LA with first and second ends 20a, 20b and at least one opening 20o. Preferably the at least one opening 20o is at one or both ends 20a, 20b. During operations of the clip and rail attachment system 10 the longitudinal axis LA of the rail 20 is preferably aligned substantially parallel to the horizontal plane H. However, if there is sufficient tension or friction manufactured in the components of the clip and rail attachment system 10 (as further described below), the longitudinal axis LA of the rail 20 may be at an angle that is significantly offset from the horizontal plane H.

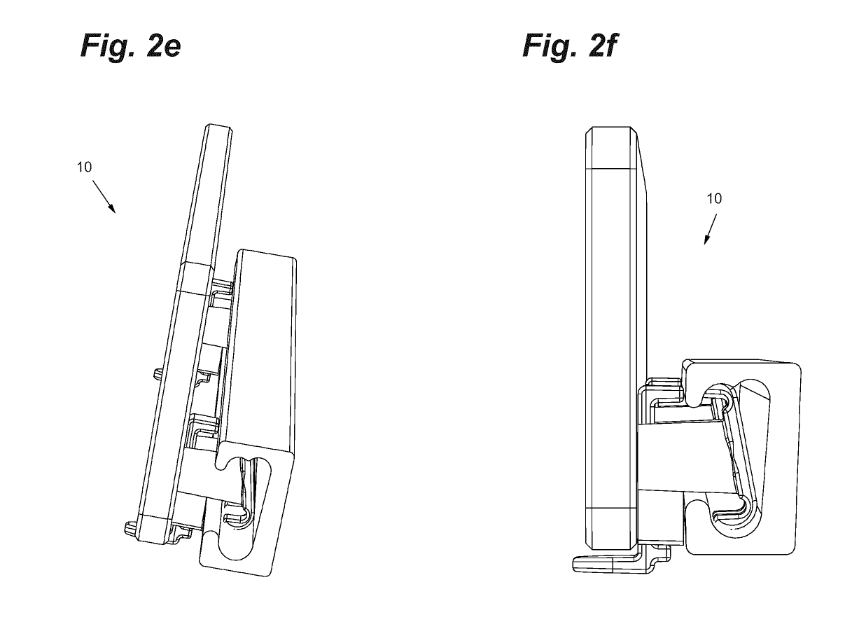

Openings 20o may be positioned at either or both ends 20a, 20b (see FIG. 3a). Rail 20 may be formed from extruded aluminum or from different materials while operating within the scope of the present invention. Accessory 15 may be anything that is desirable to be slidably mounted (to rail member 20), such as mounting brackets, lamps, cup holders, fans, trays, support ledges, keyboards, displays, signage, electronic devices, etc. Accessory 15 may be mounted to the rail clip 40 in a conventional manner, such as via threadable fasteners 17.

The rail 20 includes a channel 30 that extends for substantially the length of the rail 20 along its longitudinal axis LA. Channel 30 meets and communicates with the at least one opening 20o. Channel 30 further comprises a longitudinal opening 30o or passage to allow a portion of the clip 40 to extend out from the channel 30 while clip 40 is supported by, captured by, and sliding along rail 20 (see FIGS. 1c-1d). Preferably longitudinal opening 30o extends substantially along the rail's longitudinal axis LA (see FIG. 3a).

Channel 30 may further comprise two retaining shoulders 32 that act to retain clip 40 within the rail 20 while clip 40 is supported by, captured by, and sliding along rail 20. When the longitudinal axis LA of the rail 20 is aligned substantially parallel to the horizontal plane H, these retaining shoulders 32, may be referred to as upper retaining shoulder 32u and lower retaining shoulder 321 (see FIG. 1a). In the embodiment of FIGS. 1a-3d and 5a-10b, longitudinal opening 30o is defined by upper retaining shoulder 32u, lower retaining shoulder 321 and the two openings 20o at ends 20a, 20b of the rail 20.

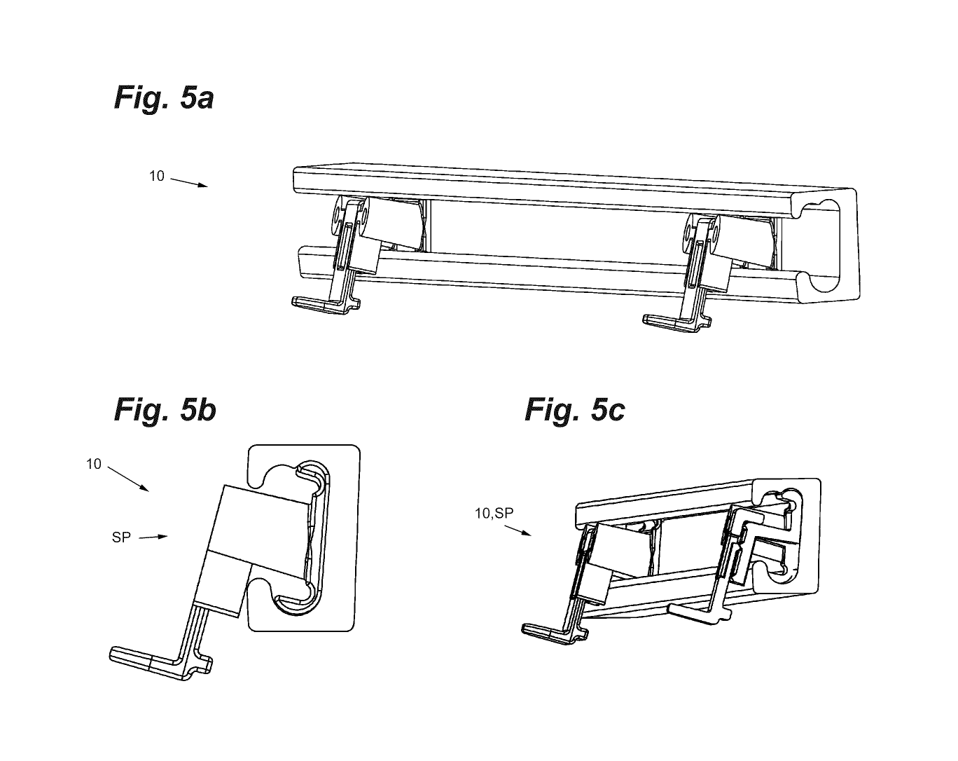

Both channel 30 and the openings 20o are of suitable size and dimensions to receive a portion of clip 40, so as to allow clip 40 to be supported and captured by rail 20 and to slide S therealong in a direction that is substantially parallel to the rail's longitudinal axis LA (see FIGS. 1a-1b). Such portion of the clip 40 (that is received by channel 30) may then be referred to as a channel engagement member 42. In contrast, that portion of the clip 40 that is outside of the rail 20 and channel 30 (during operation of the clip and rail attachment system 10) may be referred to as the accessory mounting member 44; while any portion of the clip 40 that connects these two 42, 44 and which extends through longitudinal opening 30o (during operations) may be referred to as interconnecting member 46; see FIG. 6b. In other embodiments of the clip 40 (not shown), channel engagement member 42 may be directly connected to accessory mounting member 44.

Channel 30 further comprises a plurality of grooves or curved surfaces 34, 36 that preferably extend in a direction that is substantially parallel to the rail's longitudinal axis LA and are suitable to accept the channel engagement member 42. In the embodiment of FIGS. 1a-3d and 5a-10b, channel 30 comprises three such grooves or curved surfaces, namely a first groove 34, a second groove 36s and a third groove 36l. Second and third grooves 36s, 36l are positioned within channel 30 so as to generally be facing opposite to the first groove 34 (see FIGS. 3c-3d). When the longitudinal axis LA of the rail 20 is aligned substantially parallel to the horizontal plane H, these grooves may be referred to as upper grooves 36s, 36l and lower grooves 34. In another embodiment (not shown), first groove 34 is the upper groove, while second and third grooves 36s, 36l are the lower grooves (when the longitudinal axis LA of the rail 20 is aligned substantially parallel to the horizontal plane H).

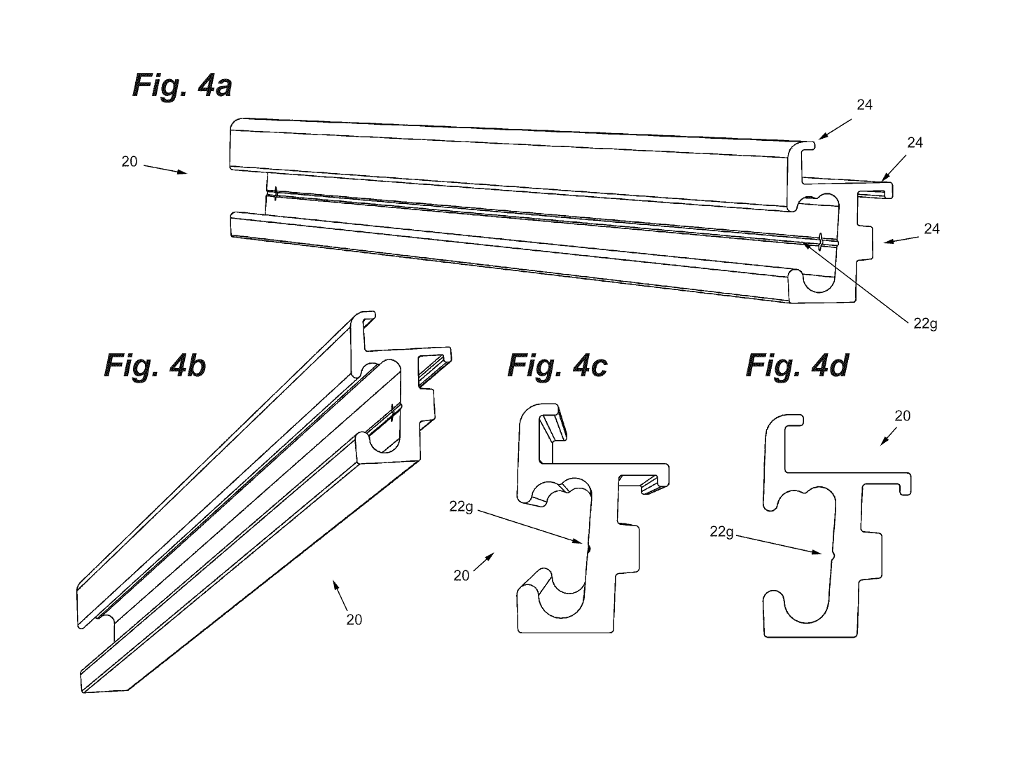

In the embodiment of FIGS. 1a-3d and 5a-10b, the distance D1 between the first groove 34 and the second groove 36s is greater than the distance D2 between the first groove 34 and the third groove 36l. Distance D1 and the dimensions of grooves 34 and 36s, and the dimensions of the clip 40, are such that when the channel engagement member 42 of the clip 40 is positioned therewithin, spanning D1, clip 40 is free to slide S along the longitudinal axis LA of the rail member 20 (see FIGS. 5b-5c). When the clip 4 is in such a position, this may be referred to as being in a sliding position SP (see FIGS. 5a-5c).

Further in the embodiment of FIGS. 1a-3d and 5a-10b, the distance D2 and the dimensions of grooves 34 and 36l, and the dimensions of the clip 40, are such that when the channel engagement member 42 of the clip 40 is positioned therewithin, spanning D2, clip 40 is securely retained and fastened to the rail (see FIGS. 6b-6c). When the clip 4 is in such a position, this may be referred to as being in a locked or secured position LP (see FIGS. 6a-6c).

As such, second groove 36s can then be referred to as a sliding groove (because it allows clip 40 to slide therealong), while third groove 36l can then be referred to as a lock groove because it securely locks and fastens clip 40 to rail 20. In either such case of being in the sliding position SP or the locked position LP, and when the longitudinal axis LA of the rail 20 is aligned substantially parallel to the horizontal plane H, most of the weight of the clip 40 and the load of any accessory 15 will be carried by first groove 34, as this weight or load is transmitted down the vertical plane V.

In the embodiment of FIGS. 1a-3d and 5a-10b, the third locking groove 36l is positioned closest to the longitudinal opening 30o. Advantageously, the arrangement of this embodiment provides a natural tendency for the clip 40 to rotate or pivot P into (or remain within) the locked position LP when a load or accessory 15 is placed on the clip 40 and the longitudinal axis LA of the rail 20 is aligned substantially parallel to the horizontal plane H. In another embodiment (not shown), it is the second groove 36s that is closest to the longitudinal opening 30.

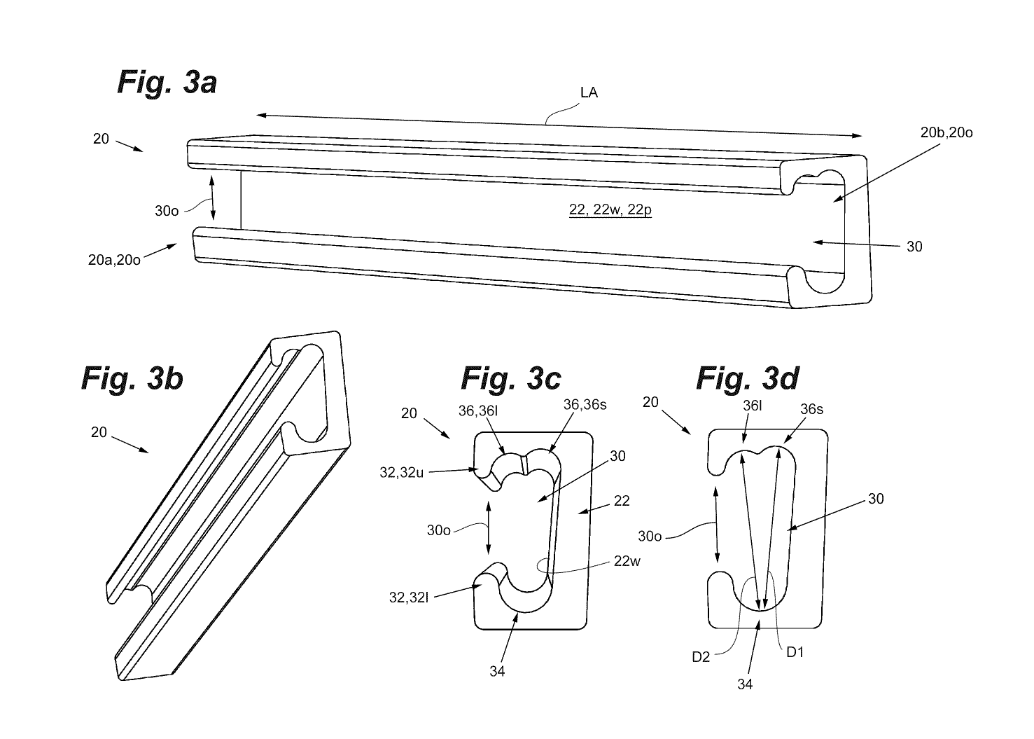

The rail 20 may be a unitary member (as shown in the figures) or multi-part. If it is a unitary member, web or rail material 22 preferably interconnects that portion of the rail that features the first groove 34, with that portion of the rail 20 that features the second 36l and third grooves 36l (see FIG. 3c). Preferably, web 22 has a substantial planar interior surface 22p to allow easy sliding of clip 40 along the channel 30. Rail 20 may also further comprise connector projections or lateral portions 24 (see FIGS. 4a-4d), to facilitate attachment of rail 20 to a piece of fitness, office or other equipment. Web 22 may also further comprise a substantially linear groove 22g (that runs parallel with the rail's longitudinal axis LA), to facilitate sliding of the clip 40 therealong and/or to allow ease of positioning of fasteners (such as screws) to allow rail 20 to be fastened to a piece of equipment (see FIGS. 4a-4d).

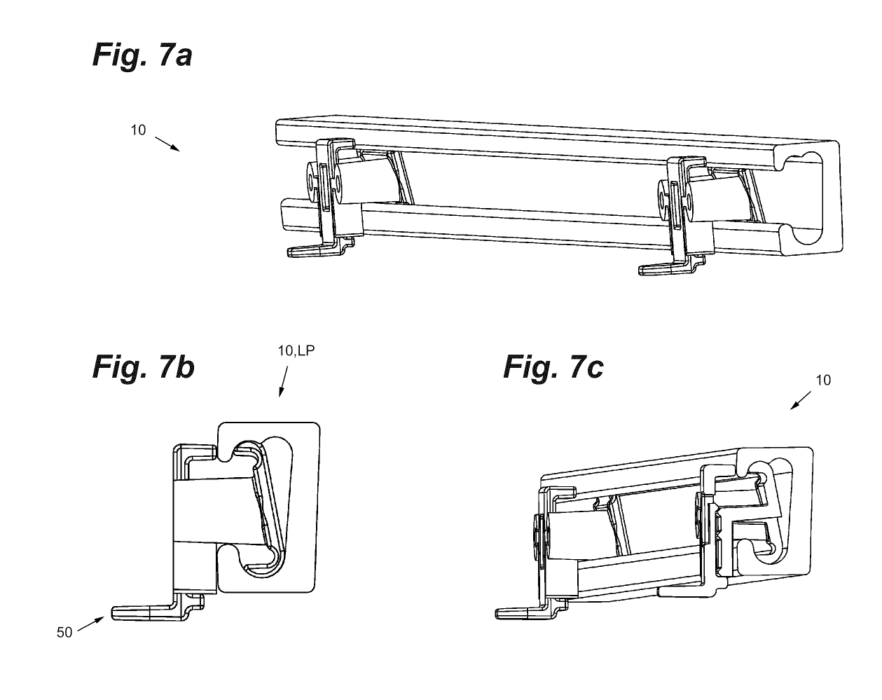

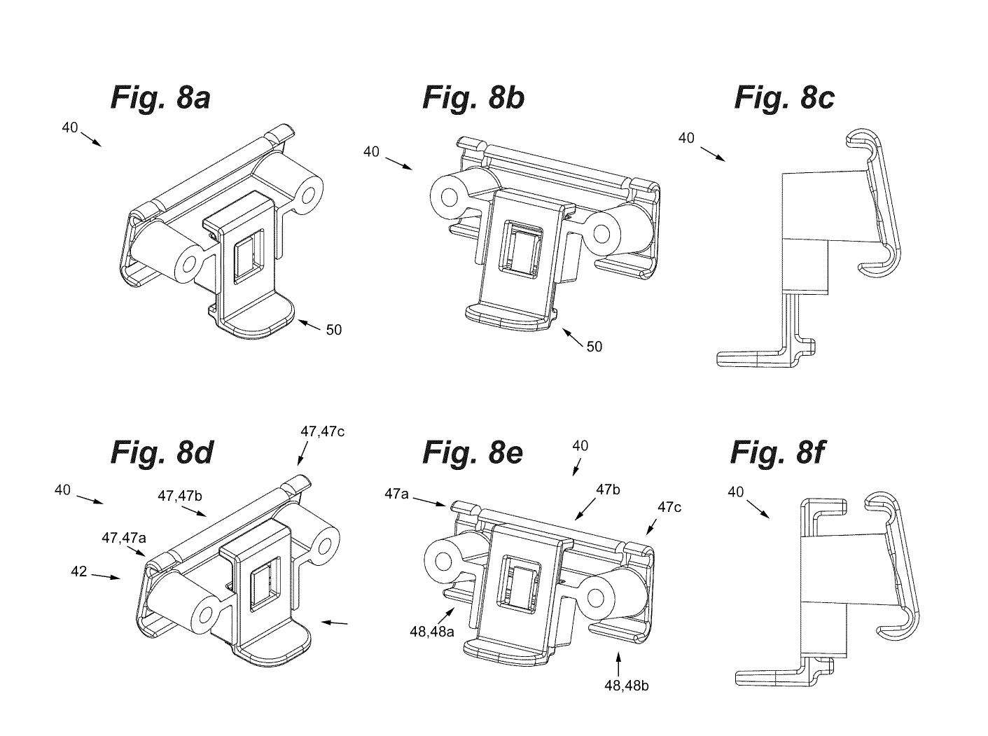

In the embodiment of FIGS. 1a-3d and 5a-10b, channel engagement member 42 of the clip 40 further comprises a plurality of channel groove engagement tabs or lobes 47, 48. In this embodiment, there is a first set of three lobes 47a, 47b, 47c and a second set of two lobes 48a, 48b (see: FIGS. 8a-8f). Lobes 47a, 47b and 47c are suitable to engage with, and slide along either of the second 36s and third 36l grooves; while lobes 48a, and 48b are suitable to engage with, and slide along the first groove 34.

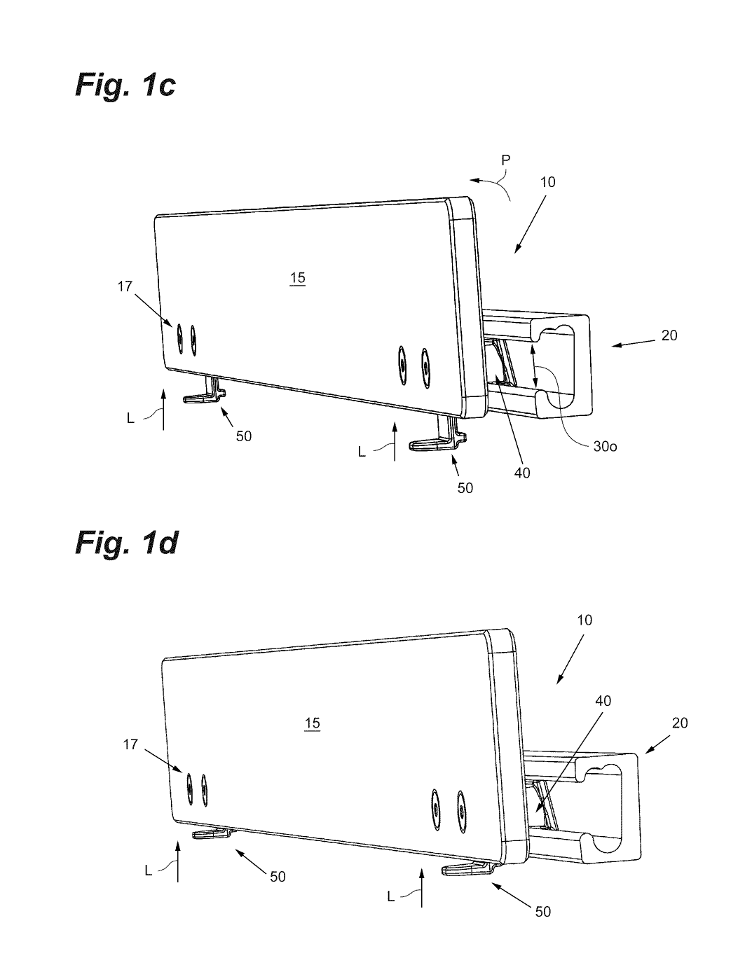

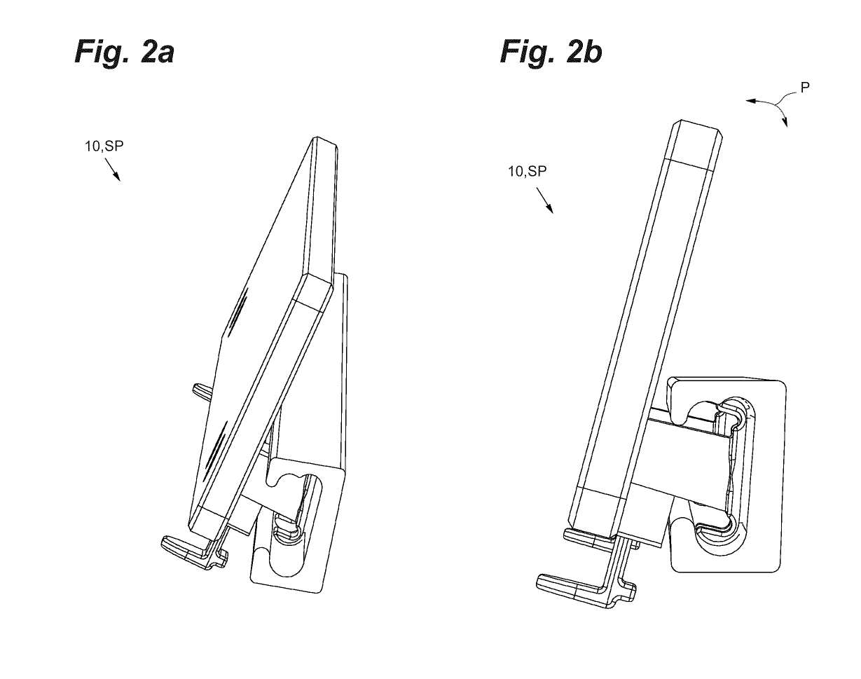

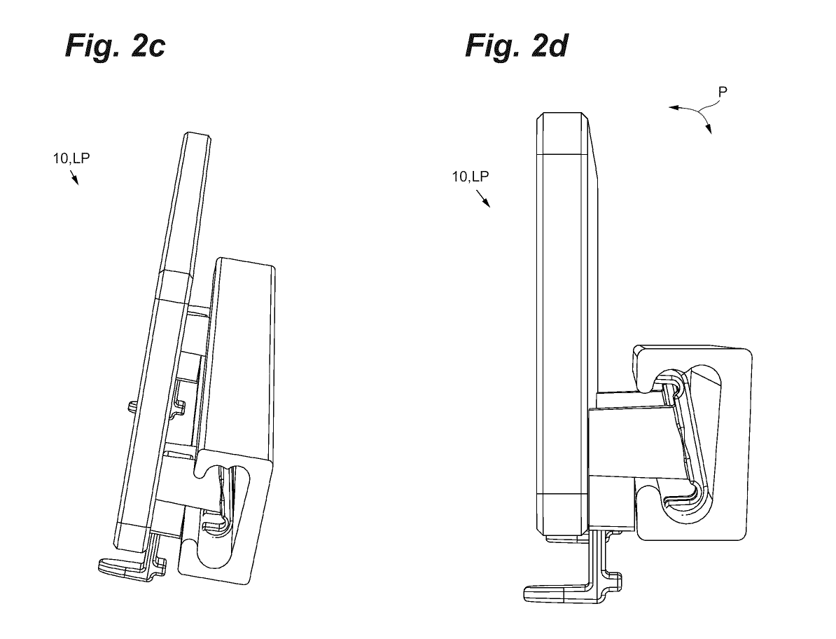

Preferably lobes 47, 48 are flexible and provide a sufficient tension or force (along with the distance D2) to keep the clip 40 secured and fastened to the rail when it is in the locked position LP. Advantageous, a user of the system 10 no longer has to guess how much tension needs to be applied to put a clip into a locked or secured position. More preferably, lobes 47, 48 are dimensioned and sized (along with the distance D1) to allow the clip 40 to slide along the rail 20 when it is in the sliding position SP. Even more preferably, lobes 47, 48 are flexible enough to allow the clip 40 (and its channel engagement member 42) to pivot P within channel 30 between the sliding position SP and the locked position LP (e.g. compare FIG. 2b in the locked position LP with FIG. 2d in the sliding position SP). Advantageously, the clips 40 are easily moved between such positions SP, LP and allow a user of the system 10 to easily reconfigure the position of the clips 40 along the rail 20.

Yet even more preferably, a present tension (or flexibility) may be provided to the lobes 47, 48 so as to create an audible signal (e.g. a “click”) or even a touch signal (e.g. a snap or vibration) when the clip 40 is pivoted P within channel 30 between the sliding position SP and the locked position LP. Advantageously, a user of the system 10 will then be provided with feedback (audible and touch) when the clip 40 is pivoted between the sliding position SP and the locked position LP. More advantageously, by only requiring a small amount of pivot P action, to put a clip 40 in a locked or secured position along a rail 20, the system 10 can be used in cases where there is little space (e.g. when used on a piece of fitness equipment up against a side wall)—because there is no longer a thumbscrew or regular screw that needs to be fastened or accessed by a tool. Even more advantageously, the system 10 will allow quick and easy switching between sliding position SP and locked position LP by simple pivoting P movement of the clips 40.

More preferably, tabs 47a and 47c are positioned at the end of the set of lobes 47 (as shown in the figures) and are slightly larger and/or taller than lobe 47b positioned therebetween (see: FIGS. 8b and 8e which illustrates that these lobes 47a, 47c are slightly larger than lobe 47b). Advantageously, tabs 47a and 47c can be manufactured to a desired tension specification to ensure secure locking of the clip 40 when in the locked position LP and also to allow ease of pivoting P of the clip between the locked position LP and the sliding position SP.

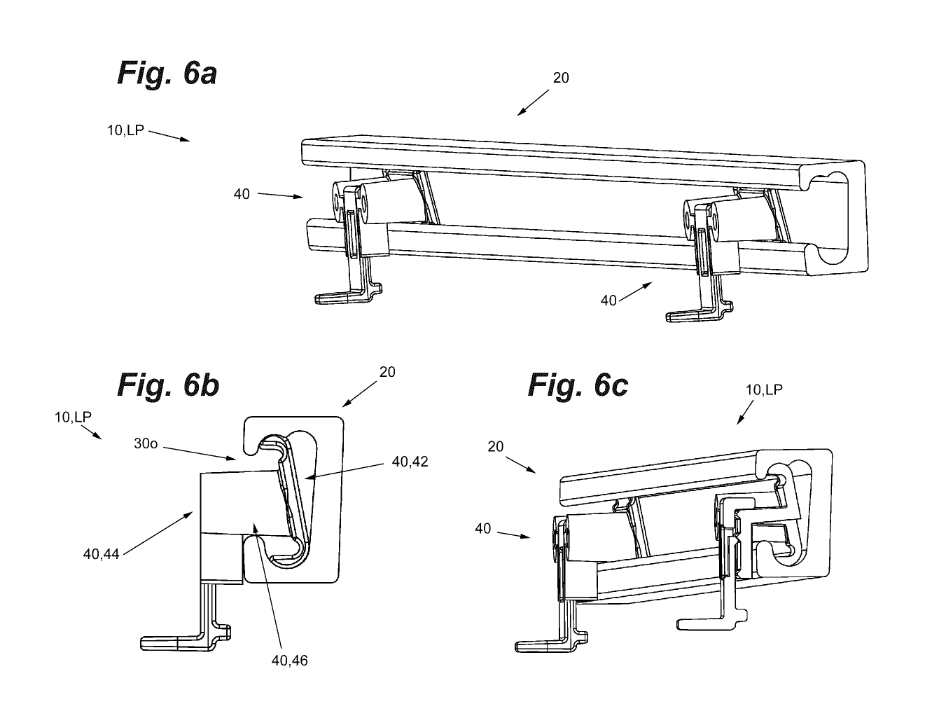

Preferably, a secondary lock member 50 is provided to retain the clip 40 within the locked position LP and prevent pivoting P of the clip 40 back to the sliding position SP (such as by engaging or pressing against the upper retaining shoulder 32u; see FIGS. 2e and 7b). Secondary lock member 50 may be slidably attached to interconnecting member 46 (to move into a locking arrangement L) and may be provided with a friction mechanism 55 to maintain it in a desired position.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

The embodiments of the invention in which an exclusive property or privilege is being claimed are defined as follows:

1. A clip and rail attachment system, for mounting an accessory, the system comprising:
at least one rail member having a longitudinal axis, a first end, a second end, a channel that extends substantially along the longitudinal axis, at least one opening, and a longitudinal opening;
at least one rail clip, having a channel engagement member and a mounting member, the at least one rail clip being suitable for slidable movement along the rail member and for supporting the accessory on the mounting member;
wherein the channel communicates with the at least one opening;
wherein the longitudinal opening allows for the mounting member to extend out from the channel while clip is supported by the rail; and
wherein the channel and the at least one opening are each of suitable size and dimension to receive the channel engagement member, so as to allow rail clip to be captured by the rail member and to slide therealong in a direction that is substantially parallel to the longitudinal axis.

2. The clip and rail attachment system of claim 1 wherein the rail member further comprises two retaining shoulders.

3. The clip and rail attachment system of claim 1 wherein the channel further comprises a plurality of grooves.

4. The clip and rail attachment system of claim 3 wherein the channel further comprises a first groove, a second groove and a third groove; and
wherein the second and third grooves are positioned within the channel so as to generally be facing opposite to the first groove.

5. The clip and rail attachment system of claim 4 wherein the distance between the first groove and the second groove is a first distance;
wherein the distance between the first groove and the third groove is a second distance;
wherein the first distance is greater than the second distance;
wherein the first distance is of suitable size and dimensions to allow the channel engagement member to be positioned therewithin and allow the rail clip to slide along the longitudinal axis; and
wherein the second distance is of suitable size and dimensions to allow the channel engagement member to be positioned therewithin and then securely retain the rail clip thereto.

6. The clip and rail attachment system of claim 5 wherein the third groove is positioned closest to the longitudinal opening.

7. The clip and rail attachment system of claim 6 wherein the channel engagement member further comprises a plurality of channel groove engagement lobes suitable to engage with one or more of the plurality of grooves.

8. The clip and rail attachment system of claim 7 wherein the plurality of channel groove engagement lobes are flexible and provide sufficient tension to keep the rail clip in a locked position, when the channel engagement member is positioned within the second distance.

9. The clip and rail attachment system of claim 8 wherein the plurality of channel groove engagement lobes are flexible and provide sufficient tension to maintain the rail clip in a sliding position, when the channel engagement member is positioned within the first distance.

10. The clip and rail attachment system of claim 9 wherein the lobes are sufficiently flexible to allow the rail clip to pivot within the channel, between the sliding position and the locked position.

11. The clip and rail attachment system of claim 10 wherein the lobes create an audible signal when the rail clip is pivoted within the channel, between the sliding position and the locked position.

12. The clip and rail attachment system of claim 11, further comprising a secondary lock member to retain the rail clip in the locked position.
